(19) United States
(12) Patent Application Publication
(10) Pub. No.: US 2003/0217852 A1
(43) Pub. Date: Nov. 27, 2003

(54) Hitch for a work vehicle

(75) Inventors: Gerd Bernhardt, Hanichen (DE); Sergiy Fedotov, Dresden (DE); Ruslan Rudik, Dresden (DE)

Correspondence Address: Joel S. Carter, Patent Department, DEERE & COMPANY, John Deere Road, Moline, IL, 61265-8098, US

(73) Assignee: Deere & Company, a Delaware Corporation

(21) Appl. No.: 10/426,767

(22) Filed: Apr. 30, 2003

(30) Foreign Application Priority Data
May 11, 2002 (DE) 102 20 998.7

(51) Int. Cl. A01B 5/00

(52) U.S. Cl. 172/200

(57) ABSTRACT

A hitch for a work vehicle includes a plurality of links pivotally coupled to a vehicle body and to an implement, either directly or indirectly via a hitch frame or quick coupler. The hitch preferably includes at least one upper link, two lower links and two longitudinally adjustable lift links for raising and lowering the hitch. Each lift link is coupled to an associated lower link near an aft end thereof. The hitch may selectively comprise both rigid and longitudinally adjustable links. The functionality of the hitch can be changed by replacing, adding or removing links. The hitch can be converted between a simple three-point hitch and a “hexapod” type hitch.

### BACKGROUND

The present invention relates to a hitch for coupling an implement to a work vehicle.

Vehicle/implement hitches are used to couple various implements to a work vehicle, such as to couple a farm implements to a tractor. A known hitch, such as described in standard ISO 730, has an upper link or upper rod, two lower links, and two lift cylinders which are coupled to a central area of the lower links. Such a hitch is known as a three-point implement hitch. However, the functionality of such a three-point hitch is limited since only a raising and a lowering of the lower links is possible with the lifting cylinders. Other motions cannot be executed by controlling the lifting cylinders.

It has been proposed that a hydraulic cylinder be used as an upper link so that the hitched implement can be tilted about a horizontal axis running transversely to the longitudinal axis of the vehicle. It is also known to control the lateral deflection of the lower links with lateral struts. The lateral struts can be longitudinally adjustable and activated hydraulically. In addition to a lateral stabilizing of the lower links the lateral struts can serve to influence the lateral alignment of the working implement. However, the functionality of the hitch remains limited even with these measures.

U.S. Pat. No. 6,321,851 describes a hitch with six longitudinally adjustable links connected between the vehicle and the implement in the a hexapod system. Such a hitch permit motion of the hitched implement with six degrees of freedom. However, such freedom of motion is not always required in practice, such as when an implement is merely being pulled by the vehicle. On the other hand, it is desirable to have a simple hitch with improved functionality and improved comfort.

### SUMMARY

Accordingly, an object of this invention is to provide a simple hitch with improved functionality and improved comfort.

This and other objects are achieved by the present invention, wherein hitch lift links are coupled to lower or draft links near to the aft ends thereof, rather than the central portions thereof. The hitch links may selectively be rigid and longitudinally adjustable so that the functionality of the hitch can be varied by replacing, adding or removing the links of the hitch. The rigid links are manually mechanically adjustable. The length of the longitudinally adjustable links can be automatically adjusted by a control mechanism.

With such links, the end user may construct a hitch or implement interface as desired for particular requirements. The hitch may be converted as needed by replacing, adding and removing structural links. In particular, it would be possible to rapidly modify a standard simple three-point hitch in a step-by-step manner to achieve the versatile functionality of a hexapod hitch. The hitch can consist of a few types of similar links, preferably, six substantially identical, longitudinally adjustable links with associated control means, two rigid lower links and one rigid upper link whose length can optionally be mechanically adjusted. If needed, other components can be added, such as a hitch frame and rigid or longitudinally adjustable lateral stabilizers. Such a simple hitch may be supplemented as needed by purchasing other components.

Preferably, the longitudinally adjustable links, especially the upper and the lower links and the lift links are substantially identical. This permits use of a simpler control mechanism. The great number of identical parts can keep the manufacturing cost and the storage cost of the structural unit low.

Each longitudinally adjustable link can include a hydraulic or electric drive for automatically adjusting its length. It is advantageous to use hydraulic cylinders, such as double-acting hydraulic cylinders. Preferably, the links are coupled and arranged to form closed, kinematic structures so that it is possible to arrange the links in a hexapod such as described in EP-A-1,095,549.

Preferably, the links are coupled to the frame or implement in a manner which permits relative motion in at least two degrees of freedom. For example, universal joints with pivot axes arranged at 90 degrees to each other and making two degrees of rotational freedom available, or ball-and-socket joints that additionally offer a degree of rotational freedom are suitable.

In a first preferred embodiment, the hitch includes a conventional upper, central link and two conventional rigid lower links. Lift links are coupled near the free ends of the lower links. If the upper link is a rigid or a mechanically adjustable link, the resulting hitch functions as a customary three-point hitch, and an implement can be automatically raised and lowered by the lift links. If the rigid upper link is replaced by an adjustable link, then the implement also can be automatically tilted about a transverse horizontal axis.

In the embodiments with only one upper link, the rigid lower links behave substantially as in a customary three-point hitch. In this instance it is advantageous to use known lateral stabilizers that act on a central area of the lower links.

Currently, a hitch may be automatically laterally aligned within given limits by laterally stabilizing hydraulic cylinders. Instead of these lateral stabilizers, hydraulic lateral stabilization can be performed by two upper longitudinally adjustable links, instead of the only one upper link. The first embodiment can be converted to this configuration by replacing the single upper link with two longitudinally adjustable links.

Preferably, the two upper links are coupled at the same height and are preferably aligned in a “V” with their first ends spaced farther apart than their second ends. The base of the V can selectively face the vehicle or the implement. However, preferably, the first ends of the upper links are coupled to the vehicle body and the closer second ends are coupled to the implement or to the coupling frame. The V-shaped system adds another controllable degree of freedom since now even the lateral alignment of the implement relative to the vehicle can be automatically adjusted.

A third embodiment includes two upper, longitudinally adjustable links arranged in a V relative to one another, two lower, lateral, longitudinally adjustable links and two lift links which are coupled to the free ends of the lower links. The third embodiment may be formed by replacing the two rigid lower links of the second embodiment with longitudinally adjustable links. The third embodiment makes possible movement with six degrees of freedom, namely, translatory motions in three directions and rotational motions about three axes. The functionality of a hexapod hitch is therewith achieved.

In another, especially preferred embodiment, the vehicle-side coupling joints of a lower link and the vehicle-side coupling joints of a lift link are located in a vertical plane. Preferably, the vehicle-side coupling points of the lower link and of the lift link are arranged approximately in a vertically superposed manner. This makes possible a free lateral pivoting out of the hitch, which is necessary in a few applications. In the second and the third embodiments described above, the two upper, longitudinally adjustable links must be shifted to the floating position for a free, lateral pivoting out.

It is also advantageous to arrange the vehicle-side coupling joint of the lift link near and approximately perpendicular across the vehicle side coupling joint of the upper link.

It is also advantageous if the upper links and the lift links have a horizontal convergence and if their vehicle coupling joints are closer together than their implement coupling joints. This convergence results in a guide point whose relative position to the work vehicle can be influenced by appropriately controlling the links in an advantageous manner as described in DE-A-10 120 732. Preferably, identical or similar coupling joints are used to reduce cost and complexity.

To provide a modular unit that is easy to handle, the coupling joints are preferably designed as separate components that can be mounted and dismounted as required on the vehicle body and/or on the implement or on the hitch frame. Threaded bores may be formed in advance on the vehicle body and on the implement or on the coupling frame so that a conversion is possible at all times. This design makes it possible to use only as many coupling points as are actually needed. Superfluous coupling points do not need to be acquired or can be dismounted.

Each adjustable link is preferably associated with its own separate control system. For example, a separate hydraulic valve system is used for each hydraulic cylinder. The control systems can be designed to be identical or similar so that the number of different components is kept low.

It is furthermore advantageous to design the control systems in such a manner that they can be readily mounted and dismounted at any time to the vehicle body or implement or coupling frame so that the number of control systems used can be adapted to the particular requirement. In particular, in order to save structural space and assure good accessibility, the controls can be mounted in series close to each other on the vehicle body, e.g., on a differential transmission housing.

### BRIEF DESCRIPTION OF THE DRAWINGS

FIG. 1 is a perspective view of a first embodiment of the hitch of the invention.

FIG. 2 is a perspective view of a modification of the hitch of FIG. 1.

FIG. 3 is a perspective view of a second embodiment of the hitch of the invention.

FIG. 4 is a perspective view of a third embodiment of the hitch of the invention.

FIG. 5 is a top view onto the hitch of FIG. 4.

FIG. 6 is a side view of the hitch of FIG. 4.

### DETAILED DESCRIPTION

In the following description the same reference numerals are used for identically or similarly designed structural components with the same functionality.

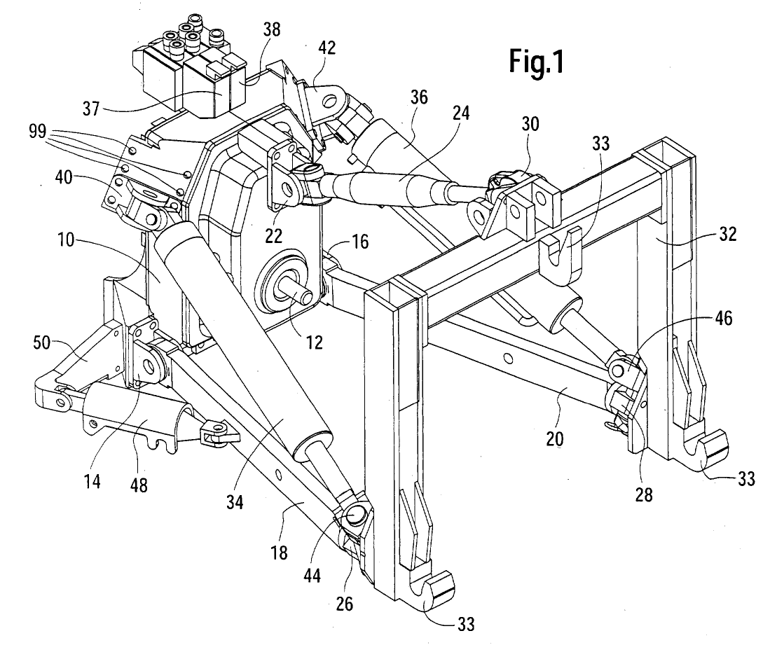

FIG. 1 shows a part of a differential transmission housing 10 that is located in the rear of a tractor (not shown) and forms a vehicle body. A power takeoff shaft 12 exits from the central area of transmission housing 10. A coupling joint 14, 16, each of which serves to articulate a rigid link 18, 20, is located on each side of transmission housing 10 on its lower area. Links 18, 20 are customary lower links designed as fixed length, rigid components. Coupling joints 14, 16 can also be designed in a customary manner. They include a ball-and-socket joint so that lower links 18, 20 can pivot about a horizontally axis in a vertical direction and can be deflected laterally within narrow limits.

A central upper coupling joint 22 is located above power take-off shaft 12 and pivotally supports rigid upper link 24. Link 24 can have a length which can be adjusted mechanically by screwing a spindle in or out. Upper coupling joint 22 comprises a universal joint so that the upper link can be pivoted laterally and in a vertical direction relative to transmission housing 10.

The free ends of the two lower links 18, 20 and of upper link 24 are pivotally coupled by coupling joints 26, 28, 30 to a coupling frame 32 which has an inverted U-shape. Coupling joints 26, 28, 30 can be universal joints. Coupling frame 32 includes three coupling hooks 33 for receiving an implement (not shown). Alternatively, it is also possible to pivotally couple the free ends of links 18, 20, 24 directly to an implement.

Two longitudinally adjustable lift links 34, 36, each of which comprises a double-acting hydraulic cylinder, are used to raise and lower coupling frame 32 and the hitched implement. The control of the hydraulic cylinders takes place for each via one of hydraulic control systems 37, 38. Control systems 37, 38 are mounted adjacent to one another on the top of transmission housing 10 and include conventional control valves.

The vehicle end of the lift links 34, 36 is pivotally coupled to the transmission housing 10 via universal type coupling joints 40, 42. The free end of each lift links 34, 36 is not coupled to a central portion of the associated lower link (as is customary in the case of a known three-point hitch), but rather is articulated via coupling joints 44, 46 to coupling frame 32. Alternatively, the free end of lift links 34, 36 can also be coupled directly to an implement (not shown). This selection of the action point of the free end of lift link 34, 36 provides increased functionality in a simple manner wherein the lift links 34, 36 can be retained and arranged in closed kinematic structures, and provides a great number of degrees of freedom of movement for the hitch.

Coupling joints 44, 46 are located near to coupling joints 26, 28, whereas coupling joints 40, 42 are spaced farther apart and are located substantially vertically over these positions. Thus, coupling joints 14, 40 are located substantially in a vertical plane. As a result, the coupling frame and the implement relative to the vehicle may be deflected laterally.

In order to limit or adjust the lateral deflection of coupling frame 32, a mechanical lateral stabilizer 48 acts on a central area of each lower link 18, 20 in a customary manner, the other end of which stabilizer is pivotally coupled to transmission housing 10 or to the vehicle chassis with interposition of holder 50. FIG. 1 shows only one of the two lateral stabilizers 48. Conventional known passive links acting as a stop can be used as lateral stabilizers.

The hitch shown in FIG. 1 has substantially the same functionality as a previously customary hitch.

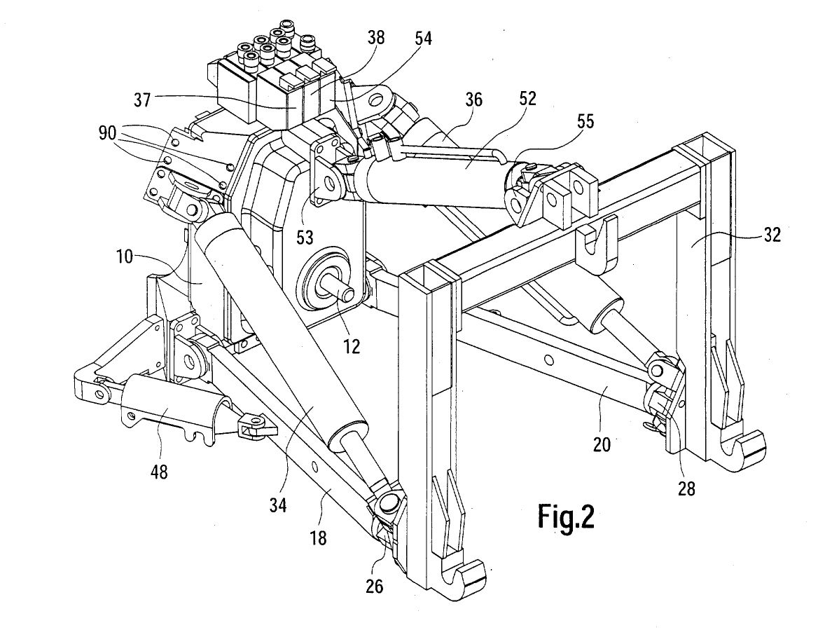

The hitch of FIG. 2 differs from the hitch of FIG. 1 solely by the design of the upper link. According to FIG. 2, upper link 52 is longitudinally adjustable and includes a hydraulic cylinder. This upper link 52 is structurally the same as the two lift links 34, 36, and is controlled by a separate control system 54 that can be mounted adjacent to the already cited control systems 37, 38 on transmission housing 10. Upper link 52 is articulated by coupling joint 53 to transmission housing 10 and by another coupling joint 55 to coupling frame 32. Both coupling joints 53, 55 are universal joints.

The hitch of FIG. 2, in addition to the functionality of the hitch of FIG. 1, can tilt about a horizontal pivot axis which extends transversely to the longitudinal axis of the vehicle and substantially through the two implement-side coupling joints 26, 28.

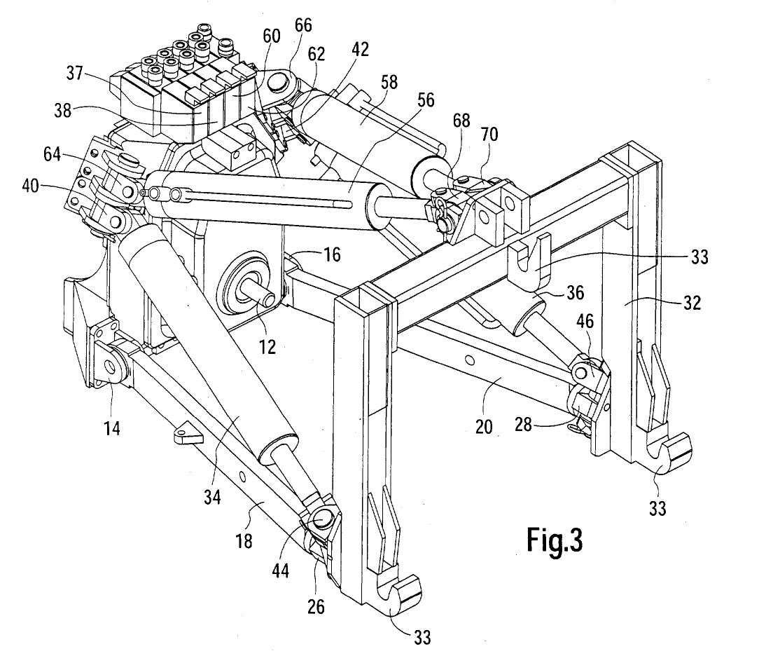

As best seen in FIG. 3, the second embodiment of the hitch includes two longitudinally adjustable links 56, 58 instead of a single upper link, and each link 56, 58 is controlled by an associated control system 60, 62. The two upper links 56, 58 are substantially structurally the same as the two lift links 34, 36. Also the four control systems 37, 38, 60, 62 are preferably designed to be structurally the same.

The two upper links 56, 58 are arranged in a V-shaped manner. Vehicle coupling joints 64, 66 are spaced far apart from one another and are located in the vicinity of and directly above coupling joints 40, 42. The two implement coupling joints 68, 70 are located at the same level and spaced closely adjacent to one another. They are coupled to coupling frame 32 or to an implement (not shown).

In this second embodiment, the stabilizers 48 of FIGS. 1 and 2 can be eliminated, since the upper links 56, 58 can assume the function of the lateral shifting of implement frame 32.

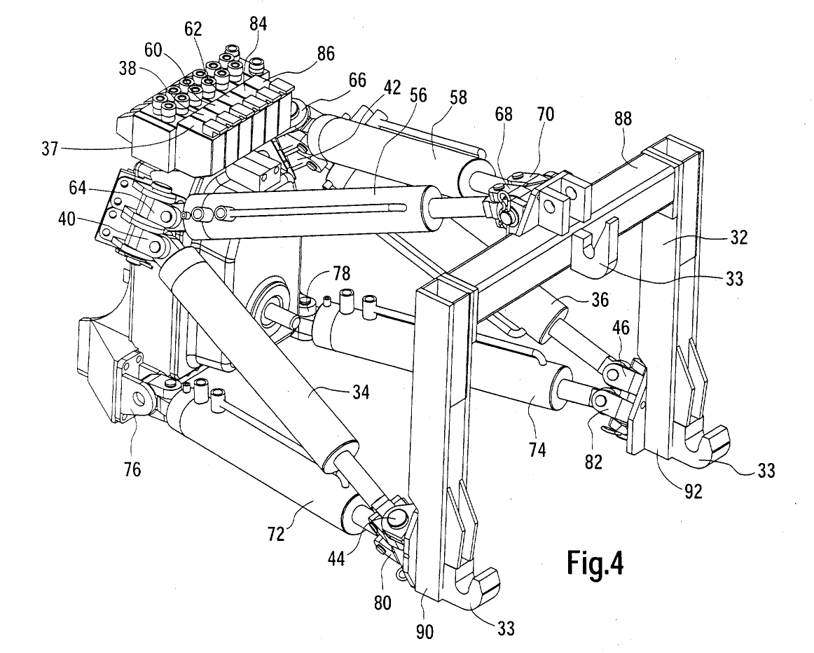

FIG. 4 shows a third embodiment of the hitch, wherein the two rigid lower links 18, 20 of FIGS. 1 to 3 are replaced by lower, longitudinally adjustable links 72, 74. Vehicle-side coupling joints 76, 78 of the lower links 72, 74 and their implement-side coupling joints 80, 82 comprise universal joints. The hitch frame 32 is connected to the vehicle body or transmission housing 10 via six identical or similar longitudinally adjustable links 34, 36, 56, 58, 72, 74. Links 34, 36, 56, 58, 72, 74 are arranged in closed, kinematic structures, and form a hexapod system. Each of the six links 34, 36, 56, 58, 72, 74 is associated with its own control system 37, 38, 60, 62, 84, 86. Control systems 37, 38, 60, 62, 84, 86 are mounted adjacent to each other on transmission housing 10.

Coupling joints 68, 70 are located close to one another in the middle of upper transverse beam 88 of implement frame 32. Coupling joints 44, 80 and 46, 82 are located on each lower free end 90, 92 of implement frame 32. Thus, the implement-side coupling joints of the six links 34, 36, 56, 58, 72, 74 are located substantially in the corner points of an isosceles triangle.

Lower links 72, 74 run substantially horizontally and are articulated by coupling joints 76, 78 to lateral lower areas of transmission housing 10. The two closely adjacent coupling joints 40, 64 and 42, 66 of each of the two lift links 34 and 36 as well as of each of the upper links 56 and 58 are located approximately vertically above these coupling joints 76, 78.

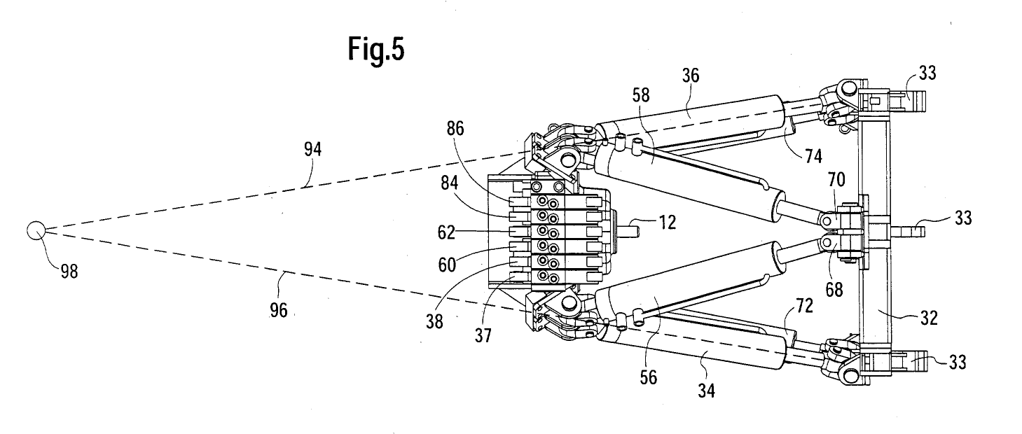

As FIG. 5 shows, the two lower links 72, 74 and the two lift links 34, 36 do not run parallel to each other. Rather, they converge horizontally so that their axes 94, 96 intersect at horizontal guide point 98. Furthermore, coupling joints 76, 78, 40, 42, 80, 82, 44, 46 are selected in such a manner that lift links 34, 36 are located vertically above lower links 72, 74. Thus, vehicle-side coupling joints 76, 40 are also located here substantially in vertical plane.

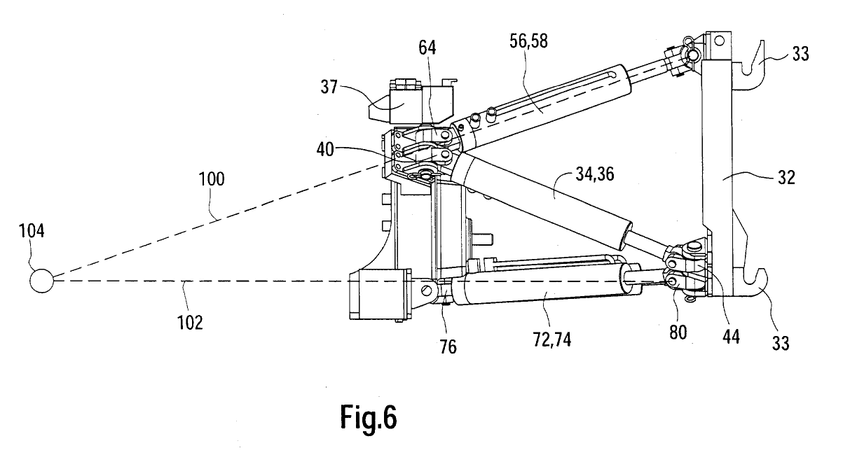

As FIG. 6 shows, the two lower links 72, 74 and the two upper links 56, 58 are not parallel to each other, but rather they converge vertically so that their axes 100, 102 intersect in a vertical guide point 104. Vertical guide point 104 and horizontal guide point 98 normally do not occupy the same spatial position. Preferably, the components of the hitch are standardized so that a small number of different components are required. In order to be able to perform any desired conversions between the three embodiments a hitch “kit” would include the following components:

six identical, longitudinally adjustable links 34, 36, 56, 58, 72, 74 with hydraulic cylinders and with coupling joints 40, 42, 44, 46, 64, 66, 68, 70, 76, 78, 80, 82 designed as universal joints;

six identical control systems 37, 38, 60, 62, 84, 86 with control valves and the hydraulic lines (not shown) for supplying longitudinally adjustable links 34, 36, 56, 58, 72, 74;

two similar, rigid lower links 18, 20, with associated coupling joints 14, 16, 26, 28 comprising ball-and-socket joints;

one upper link 24 with coupling joints 22, 30;

two mechanical lateral stabilizers 48; and

a coupling frame 32.

Mounting devices, such as threaded bores, are formed in transmission housing 10 and optionally on coupling frame 32 so that the coupling joints can be selectively coupled to the transmission housing 10 and to coupling frame 32. Preferably, the same mounting devices can be used for both rigid and longitudinally adjustable links, so that either the coupling joint 14 of a rigid lower link 18 or the coupling joint 76 of a lower, adjustable link 72 can be mounted to the same position on the transmission housing 10.

Preferably, coupling joints are mounted only for the links which are used in the selected embodiment. For example, in the first embodiment, not two, but rather only one lateral upper link is used, and threaded bores 99 for the corresponding links remain unused. The number of control systems 37, 38, 60, 62, 84, 86 used and mounted on transmission housing 10 corresponds to the number of longitudinally adjustable links used. The coupling joints of the longitudinally adjustable links are preferably universal joints. In contrast thereto, the coupling joints of the rigid lower links comprise either a ball-and-socket joint customary for lower links or also comprise universal joints that resemble the ball-and-socket joints already described for the hydraulic cylinders.

While the present invention has been described in conjunction with a specific embodiment, it is understood that many alternatives, modifications and variations will be apparent to those skilled in the art in light of the foregoing description. Accordingly, this invention is intended to embrace all such alternatives, modifications and variations which fall within the spirit and scope of the appended claims.

We claim:

1. A hitch for a work vehicle, the hitch having links pivotally coupled to a body of the vehicle, the links having aft ends for coupling directly or indirectly to an implement, the hitch having an upper link, a pair of lower links and two longitudinally adjustable lift links for raising and lowering the hitch, characterized by:
each lift link is coupled to a corresponding lower link near the aft end of the lower link, the hitch selectively including rigid links and longitudinally adjustable links so that functionality of the hitch can be changed by replacing, adding or removing links.

2. The hitch of claim 1, wherein:
the longitudinally adjustable links are substantially identical.

3. The hitch of claim 1, wherein:
each longitudinally adjustable link comprises a double-acting hydraulic cylinder.

4. The hitch of claim 1, wherein:
the links are coupled together to form a hexapod arrangement and form closed kinematic structure.

5. The hitch of claim 1, wherein:
the ends of the links are supported by coupling joints which permit relative motion in at least two degrees of freedom.

6. The hitch of claim 1, wherein:
the upper link comprises a conventional upper central link, and the lower links are conventional rigid links.

7. The hitch of claim 6, wherein:
the upper link selectively comprises a rigid link or a longitudinally adjustable link.

8. The hitch of claim 1, comprising:
a pair of longitudinally adjustable upper links, the lower links comprise conventional rigid lower links.

9. The hitch of claim 6, further comprising:
a lateral stabilizer pivotally coupled to a central portion of at least one of the rigid lower links.

10. The hitch of claim 1, comprising:
a pair of longitudinally adjustable upper links and a pair of longitudinally adjustable lower links.

11. The hitch of claim 8, wherein:
the two upper links are arranged in a V-shape at the same level, each upper link having a first end and a second end, the first ends being spaced farther apart than the second ends.

12. The hitch of claim 11, wherein:
the first ends of the upper links are coupled to the body.

13. The hitch of claim 1, wherein:
each lower link is coupled to a lower vehicle-side coupling joint, each lift link is coupled to an upper vehicle-side coupling joint, and pairs of said vehicle-side coupling joints being located in vertical planes.

14. The hitch of claim 1, wherein:
each lift link is coupled to a vehicle-side lift link coupling joint, each upper link is coupled to a vehicle-side upper link coupling joint, and each lift link coupling joint being positioned near to a corresponding upper link coupling joint.

15. The hitch of claim 1, wherein:
the lower links converge in a direction towards the vehicle.

16. The hitch of claim 1, wherein:
the upper link converges with a lower link in a direction away from the vehicle.

17. The hitch of claim 1, wherein:
the links are coupled to a plurality of similar coupling joints.

18. The hitch of claim 1, wherein:
the coupling joints comprise universal joints.

19. The hitch of claim 5, wherein:
each coupling joint may be selectively mounted or dismounted.

20. The hitch of claim 1, wherein:
each longitudinally adjustable link is associated with a separate control system.

21. The hitch of claim 20, wherein:
each control system may be selectively mounted and dismounted on the vehicle body.

22. The hitch of claim 1, further comprising:
mounting devices for selectively mounting different combinations of rigid and longitudinally adjustable links.

23. The hitch of claim 1, wherein:
the lift links converge in a direction towards the vehicle.
